(19) United States
(12) Patent Application Publication
(10) Pub. No.: US 2007/0062218 A1
(43) Pub. Date: Mar. 22, 2007

(54) Method for controlling the forming of flat glass

(76) Inventors: Christel Champinot, Boulogne Billancourt (FR); Jean-Francois Simon, Joinville-le-Pont (FR)

Correspondence Address: AIR LIQUIDE, 2700 POST OAK BOULEVARD, SUITE 1800, HOUSTON, TX, 77056, US

(21) Appl. No.: 10/570,451

(22) PCT Filed: Sep. 3, 2004
(86) PCT No.: PCT/FR04/50412

§ 371 Date: Oct. 27, 2006

(30) Foreign Application Priority Data
Sep. 9, 2003 (FR) 0350513

(51) Int. Cl. C03B 11/08; C03B 18/02

(52) U.S. Cl. 65/29.12; 65/99.2

(57) ABSTRACT

The invention relates to a method for controlling the forming of flat glass by conducting molten glass over a liquid tin layer in a forming vat. According to said method, the concentration of H₂0 above the surface of the glass during the forming process is measured by means of at least one laser diode.

The present invention relates to a method for controlling the forming of flat glass by conducting molten glass over a layer of molten tin.

In the float flat glass forming process, hot glass issuing from the melting furnace is conducted over a layer of molten tin contained in a bath. The bath consists of a metal casing of which the walls have a refractory lining. The glass spreads over the denser tin to a thickness of about 6 mm, conditioned by the combined effect of the gravitational, surface tension and tensile forces. The tensile force is applied by the rollers supporting the glass ribbon that sets in the annealing lehr located downstream of the tin bath.

Flat glass is formed under an atmosphere comprising nitrogen and hydrogen (3 to 10% by volume of the atmosphere) in order to limit the oxidation of the tin under the effect of slight ingress of air, of the degassing of the glass, and of waste substances in the nitrogen and hydrogen introduced, such as moisture. This atmosphere is maintained at slightly positive pressure and is continuously replenished to prevent the accumulation of impurities that can cause defects in the glass.

The presence of moisture and oxygen contaminates the tin and causes the emission of stannous oxide (SnO) into the atmosphere. This stannous oxide can condense on the refractory walls in the downstream part of the bath and, by chemical reduction, fall in metal drops on the glass ribbon. Moreover, the increase in the dissolved oxygen content of the tin bath causes the absorption of increasing quantities of stannous oxide on the underside of the glass ribbon. If these quantities are too high, the stannous oxide may be converted to stannic oxide during the subsequent heat treatments of the glass ribbon and form a bluish halo on the glass. Finally, since the solubility of oxygen is strongly correlated with the temperature (from 630 to 5 ppm when the tin cools from 1000 to 600° C.) and the travel of the glass causes to flow rapidly this tin from the hot upstream zone (1000° C.) to the cold downstream zone of the bath (600° C.), the dissolved oxygen in the hot zone may precipitate as stannic oxide in the cold part of the bath and cause progressive fouling of the tin bath.

To avoid these problems, it is known that the heating profile in the bath roof and the nitrogen and hydrogen flow distribution (in the form of a stream of nitrogen/hydrogen mixture and, optionally, of pure nitrogen) can be adjusted according to the operating conditions: drawing out of the glass produced, occasional temperature measurements in the chamber, glass thickness measurement and monitoring of the change over time of the proportion of manufacturing defects due to tin. The moisture content of the atmosphere can also be measured using conventional hygrometers. These hygrometers may be cooled mirror systems or IR spectrometry systems. They have the following drawbacks:
since the measurement is occasional and local, it is not necessarily representative of the overall zone considered,
they must be cleaned and calibrated frequently due to fouling by direct contact with the bath atmosphere,
the signals they generate are discontinuous (or continuous in packets), making them unusable in control loops for real-time control of the bath atmosphere and of the float glass forming conditions,
their response time may be of about one minute depending on the length of the sampling line and the temperature conditioning of the mirror.

It is the object of the present invention to propose a method for controlling the forming of flat glass by measuring the moisture content, a method without the above problems.

For this purpose, the invention relates to a method for controlling the forming of flat glass by conducting molten glass over a layer of molten tin in which the H₂O concentration above the glass surface during the forming process is measured using at least one diode laser.

Within the context of the present invention, diode laser means a measurement system comprising:
a transmitter for transmitting a laser beam preferably having a variable wavelength in a wavelength range Δd that includes at least one of the characteristic wavelengths absorbed by the species of which the presence is to be detected,
a detector for detecting this beam after it passes through the medium to be analyzed,
means for comparing, for example, the amplitude of the laser beam received (beam intensity) and the amplitude of the laser beam transmitted throughout the wavelength range considered.

According to one variant, at least one diode laser of the method installed also measures the temperature.

The diode laser may be placed at a distance of between 2 and 50 cm, preferably between 5 and 20 cm, from the glass surface during the forming process. Several diode lasers may be placed at various points along the length of the bath. Preferably, at least one diode laser measuring the H₂O concentration is placed in at least one of the following locations:
in the hot upstream zone of the bath, because the solubility of oxygen in the tin is high in this zone,
in the cold downstream zone of the bath, because the air ingress is often greater there due to the exit of the glass ribbon.

It is also preferable to place at least one diode laser measuring the temperature in the hot upstream zone of the bath. The diode lasers are positioned so that each laser beam is directed transverse to the direction of travel of the glass during the forming process.

In practice, the laser beam enters the furnace via viewing windows provided in the wall of the metal casing at a height such that the laser beam passes at a short distance above the glass surface during the forming process. The laser transmitter and receiver may be positioned behind each of these viewing windows. According to one variant, the transmitter and receiver may be placed behind the same viewing window; a mirror is placed behind the second viewing window so as to reflect the laser beam transmitted by the transmitter to the receiver. A gas, such as nitrogen, can be used to clean the surface of the viewing windows of the transmitter and receiver and, optionally, of the mirror, in order to avoid the deposition of dust and thereby prevent excessive heating of the transmitter and the receiver.

The diode laser has the advantage of taking an average measurement of the desired data along the optical path, hence across the entire width of the bath. It permits measurement a few centimeters above the glass surface during the forming process, without any element penetrating into the bath, thereby avoiding expensive maintenance of the sensors in contact with the bath atmosphere and limited or difficult access to the sensors. Moreover, the diode laser does not cause any changes in the heat transfer to the batch, contrary to the case of a probe that would be placed a few cm above the batch.

Thanks to the invention, the heating profile of the forming bath and the flow distribution of nitrogen and hydrogen introduced into the bath can be adjusted according to the values of the H₂O concentration and the temperature measured by the diode laser. The change in the proportion of defects generated by the tin and the operating conditions of the line (ouput and thickness of the glass produced) are parameters that can also be taken into account in addition to the H₂O concentration and temperature, in order to adjust the heating profile and the nitrogen and hydrogen flow distribution.

Thanks to the invention, the tin bath maintenance and/or cleaning operations can also be scheduled according to the values of the H₂O concentration measured by the diode laser. The operating conditions of the line (ouput and thickness of glass produced) can also be taken into account for scheduling these operations.

1-8. (canceled)

9. A method for controlling the forming of flat glass by conducting molten glass over a layer of molten tin present in a forming bath, characterized in that the H₂O concentration above the glass surface during the forming process is measured using at least one diode laser.

10. The method as claimed in claim 9, characterized in that at least one diode laser is used to measure the temperature.

11. The method as claimed in claim 9, characterized in that the diode laser is placed at a distance of between 2 and 50 cm, preferably between 5 and 20 cm, from the glass surface during the forming process.

12. The method as claimed in claim 9, characterized in that at least one diode laser measuring the H₂O concentration is placed in at least one of the following locations: in the hot upstream zone of the bath, and in the cold downstream zone of the bath.

13. The method as claimed in claim 9, characterized in that at least one diode laser measuring the temperature is placed in the hot upstream zone of the bath.

14. The method as claimed in claim 9, characterized in that the diode laser is positioned so that its laser beam is transverse to the direction of travel of the glass during the forming process.

15. The method as claimed in claim 10, characterized in that the heating profile of the forming bath and the flow distribution of nitrogen and hydrogen introduced into the bath are adjusted according to the values of the H₂O concentration and the temperature measured by the diode laser.

16. The method as claimed in claim 9, characterized in that the tin bath maintenance and/or cleaning operations are scheduled according to the values of the H₂O concentration measured by the diode laser.
